(19) United States
(12) Patent Application Publication
(10) Pub. No.: US 2026/0095936 A1
(43) Pub. Date: Apr. 2, 2026

(54) SYSTEM AND METHOD FOR WIRELESS NON-PRIMARY CHANNEL ACCESS (NPCA)

(71) Applicant: NXP USA, Inc., AUSTIN, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 19/341,771

(22) Filed: Sep. 26, 2025

Related U.S. Application Data
(60) Provisional application No. 63/700,075, filed on Sep. 27, 2024.
(60) Provisional application No. 63/754,312, filed on Feb. 5, 2025.
(60) Provisional application No. 63/775,911, filed on Mar. 21, 2025.

(51) Int. Cl. H04W 74/08

(52) U.S. Cl. CPC H04W 74/08

(57) ABSTRACT

Embodiments of a method and apparatus for wireless communications are disclosed. In an embodiment, a wireless device includes a controller configured to detect an Overlapping Basic Service Set (OBSS) activity and a transceiver configured to switch to a Non-Primary Channel Access (NPCA) primary channel when the OBSS activity is detected and to conduct frame exchanges in the NPCA primary channel during the OBSS activity.

### CROSS-REFERENCE TO RELATED APPLICATIONS

This application is entitled to the benefit of U.S. Provisional Patent Application Ser. No. 63/700,075, filed on Sep. 27, 2024, U.S. Provisional Patent Application Ser. No. 63/754,312, filed on Feb. 5, 2025, and U.S. Provisional Patent Application Ser. No. 63/775,911, filed on Mar. 21, 2025, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a controller configured to detect an Overlapping Basic Service Set (OBSS) activity and a transceiver configured to switch to a Non-Primary Channel Access (NPCA) primary channel when the OBSS activity is detected and to conduct frame exchanges in the NPCA primary channel during the OBSS activity. Other embodiments are also disclosed.

In an embodiment, the controller is further configured to generate an announcement regarding whether the OBSS activity includes an OBSS Physical Layer Protocol Data Unit (PPDU) or an OBSS transmit opportunity (TXOP).

In an embodiment, the OBSS activity includes the OBSS PPDU, and the wireless device switches to the NPCA primary channel if remaining time of the OBSS PPDU is longer than an OBSS activity threshold.

In an embodiment, the frame exchanges end no later than an end of the OBSS PPDU.

In an embodiment, the OBSS activity includes the OBSS TXOP, and the wireless device switches to the NPCA primary channel if remaining time of the OBSS TXOP is longer than an OBSS activity threshold.

In an embodiment, the frame exchanges end no later than an end of the OBSS TXOP.

In an embodiment, the controller is configured to generate an announcement regarding a contention window (CW) of a first backoff of a wireless station (STA) in the NPCA primary channel.

In an embodiment, the CW is one of 2*(CWmin+1)−1 and 4*(CWmin+1)−1, and CWmin represents a minimum CW value.

In an embodiment, the controller is further configured to switch to the NPCA primary channel at an end time of a received Universal Signal (U-SIG) or a High Efficiency (HE)-SIG-A if an OBSS HE, Extremely High Throughput (EHT), or Ultra High Reliability (UHR) Physical Layer Protocol Data Unit (PPDU) is received in a primary channel.

In an embodiment, the wireless device is compatible with an Institute of Electrical and Electronics Engineers (IEEE) 802.11 protocol.

In an embodiment, the wireless device includes a wireless multi-link device (MLD), and the transceiver includes a wireless transceiver configured to conduct the frame exchanges with a second wireless MLD in the NPCA primary channel during the OBSS activity through wireless links between the wireless MLD and the second wireless MLD.

In an embodiment, a method for wireless communications involves at a first wireless device, detecting an Overlapping Basic Service Set (OBSS) activity and at the first wireless device, switching to a Non-Primary Channel Access (NPCA) primary channel when the OBSS activity is detected and conducting frame exchanges in the NPCA primary channel during the OBSS activity.

In an embodiment, the method further includes generating an announcement regarding whether the OBSS activity includes an OBSS Physical Layer Protocol Data Unit (PPDU) or an OBSS transmit opportunity (TXOP).

In an embodiment, the OBSS activity includes the OBSS PPDU, and switching to the NPCA primary channel includes switching to the NPCA primary channel if remaining time of the OBSS PPDU is longer than an OBSS activity threshold.

In an embodiment, the frame exchanges end no later than an end of the OBSS PPDU.

In an embodiment, the OBSS activity includes the OBSS TXOP, and switching to the NPCA primary channel includes switching to the NPCA primary channel if remaining time of the OBSS TXOP is longer than an OBSS activity threshold.

In an embodiment, the frame exchanges end no later than an end of the OBSS TXOP.

In an embodiment, the method further includes generating an announcement regarding a contention window (CW) of a first backoff of a wireless station (STA) in the NPCA primary channel.

In an embodiment, the CW is one of 2*(CWmin+1)−1 and 4*(CWmin+1)−1, and CWmin represents a minimum CW value.

In an embodiment, switching to the NPCA primary channel when the OBSS activity is detected includes switching to the NPCA primary channel at an end time of a received Universal Signal (U-SIG) or a High Efficiency (HE)-SIG-A if an OBSS HE, Extremely High Throughput (EHT), or Ultra High Reliability (UHR) Physical Layer Protocol Data Unit (PPDU) is received in a primary channel.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with an embodiment of the disclosure.

FIG. 2 depicts a multi-link (ML) communications system that is used for wireless communications in accordance with an embodiment of the disclosure.

FIG. 3 depicts a wireless device in accordance with an embodiment of the disclosure.

FIG. 4 depicts an example channel switch operation in accordance with an embodiment of the disclosure.

FIG. 5 illustrates a frame format in accordance with an embodiment of the disclosure.

FIG. 6 illustrates an Extremely High Throughput (EHT)/Ultra High Reliability (UHR) Multi-User (MU) Physical Layer Protocol Data Unit (PPDU) format in accordance with an embodiment of the disclosure.

FIG. 7 illustrates a High Efficiency (HE) single-user (SU) PPDU format in accordance with an embodiment of the disclosure.

FIG. 8 illustrates a HE MU PPDU format in accordance with an embodiment of the disclosure.

FIG. 9 illustrates a HE trigger based (TB) PPDU format in accordance with an embodiment of the disclosure.

FIG. 10 illustrates an EHT/UHR TB PPDU format in accordance with an embodiment of the disclosure.

FIG. 11 is a process flow diagram of a method for wireless communications in accordance with an embodiment of the disclosure.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

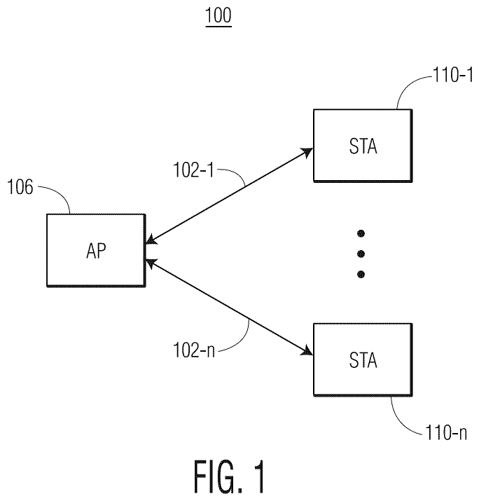

FIG. 1 depicts a wireless (e.g., WiFi) communications system 100 in accordance with an embodiment of the disclosure. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

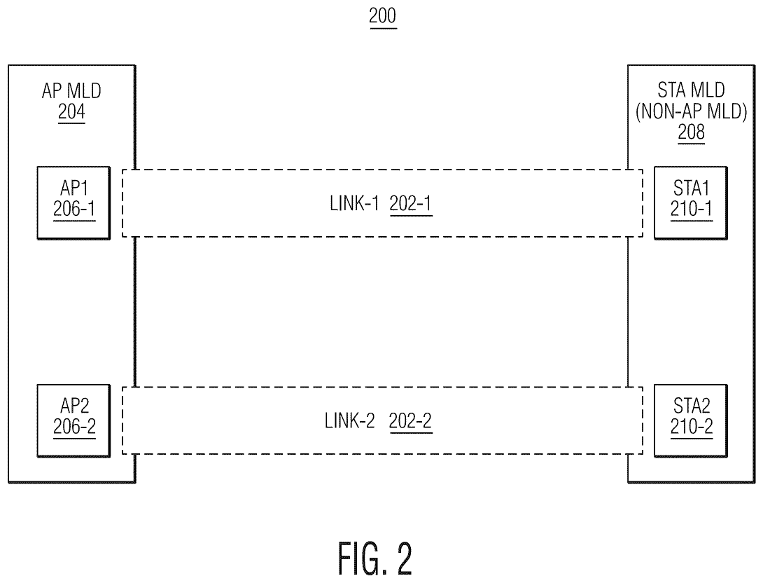

FIG. 2 depicts a multi-link (ML) communications system 200 that is used for wireless (e.g., WiFi) communications in accordance with an embodiment of the disclosure. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11 bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a channel switch announcement frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

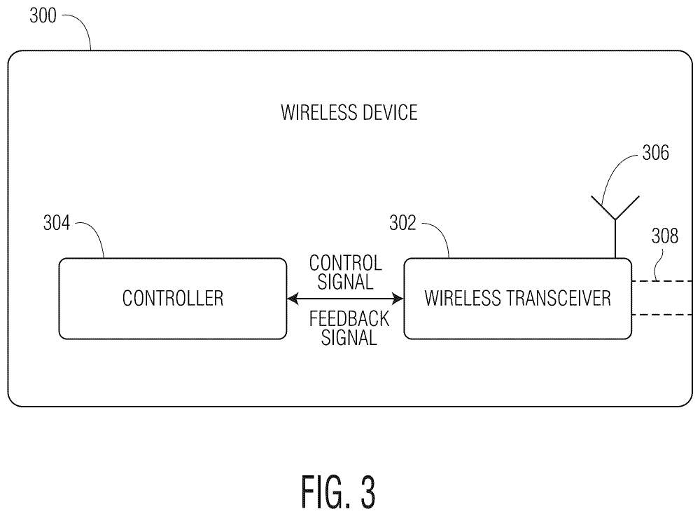

FIG. 3 depicts a wireless device 300 in accordance with an embodiment of the disclosure. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper data transmission within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

In accordance with an embodiment of the disclosure, the controller 304 is configured to detect an Overlapping Basic Service Set (OBSS) activity (e.g., detect an OBSS activity in a primary channel of a BSS operating channel), and the wireless transceiver 302 is configured to switch to a Non-Primary Channel Access (NPCA) primary channel (e.g., an NPCA primary channel of a BSS operating channel) when the OBSS activity is detected and to conduct (e.g., to participate in) frame exchanges in the NPCA primary channel during the OBSS activity, for example, through the at least one antenna 306.

In some embodiments, the controller 304 is further configured to generate an announcement regarding whether the OBSS activity includes an OBSS Physical Layer Protocol Data Unit (PPDU) or an OBSS transmit opportunity (TXOP). In some embodiments, the OBSS activity includes the OBSS PPDU, and the wireless device 300 (e.g., the wireless transceiver 302) switches to the NPCA primary channel if the remaining time of the OBSS PPDU is longer than an OBSS activity threshold. In some embodiments, the frame exchanges end no later than the end of the OBSS PPDU. In some embodiments, the OBSS activity includes the OBSS TXOP, and the 300 (e.g., the wireless transceiver 302) switches to the NPCA primary channel if the remaining time of the OBSS TXOP is longer than an OBSS activity threshold. In some embodiments, the frame exchanges end no later than the end of the OBSS TXOP. In some embodiments, the AP and the STA detecting the OBSS activity switch to the NPCA primary channel for the frame exchanges if the remaining time of the OBSS activity is longer (or no less) than the remaining time of the OBSS activity. In some embodiments, the frame exchanges in the NPCA primary channel is performed no later than the end of the OBSS activity. In some embodiments, the wireless transceiver 302 is configured to switch to the NPCA primary channel (e.g., an NPCA primary channel of a BSS operating channel) when the OBSS activity is detected and to transmit and receive frames in the NPCA primary channel during the OBSS activity, for example, through the at least one antenna 306.

In some embodiments, the wireless transceiver 302 is further configured to conduct the frame exchanges with a second wireless device in the NPCA primary channel during the OBSS activity, the wireless device 300 includes a wireless access point (AP), and the second wireless device includes a non-AP station (STA) associated with the wireless AP. In some embodiments, the wireless transceiver 302 is further configured to switch from a primary channel to the NPCA primary channel when the OBSS activity is detected and to conduct the frame exchanges with the wireless STA in the NPCA primary channel during the OBSS activity. In some embodiments, the wireless STA switches from the primary channel to the NPCA primary channel when the OBSS activity is detected.

In some embodiments, the controller 304 is configured to generate an announcement regarding whether the OBSS activity includes an OBSS Physical Layer Protocol Data Unit (PPDU) or an OBSS transmit opportunity (TXOP). In some embodiments, the wireless transceiver 302 is further configured to continue to communicate in the NPCA primary channel until an end of the OBSS activity, i.e., until the end of the OBSS PPDU when the OBSS activity includes the OBSS PPDU or until an end of the OBSS TXOP when the OBSS activity includes the OBSS TXOP.

In some embodiments, the controller 304 is configured to generate an announcement regarding a contention window (CW) of a first backoff of a wireless station (STA) in the NPCA primary channel. In some embodiments, the CW is one of 2*(CWmin+1)−1 and 4*(CWmin+1)−1, CWmin represents a minimum CW value.

In some embodiments, the controller 304 is further configured to switch to the NPCA primary channel at an end time of a received Universal Signal (U-SIG) or a High Efficiency (HE)-SIG-A if an OBSS HE, Extremely High Throughput (EHT), or Ultra High Reliability (UHR) Physical Layer Protocol Data Unit (PPDU) is received in a primary channel.

In some embodiments, the wireless device 300 is compatible with an Institute of Electrical and Electronics Engineers (IEEE) 802.11 protocol.

In some embodiments, the wireless device includes a wireless multi-link device (MLD), and the wireless transceiver 302 in a link of the MLD is configured to conduct the frame exchanges with a second wireless MLD in the NPCA primary channel of the link during the OBSS activity through wireless links between the STA/AP of wireless MLD in the link and the AP/STA of the second wireless MLD in the link.

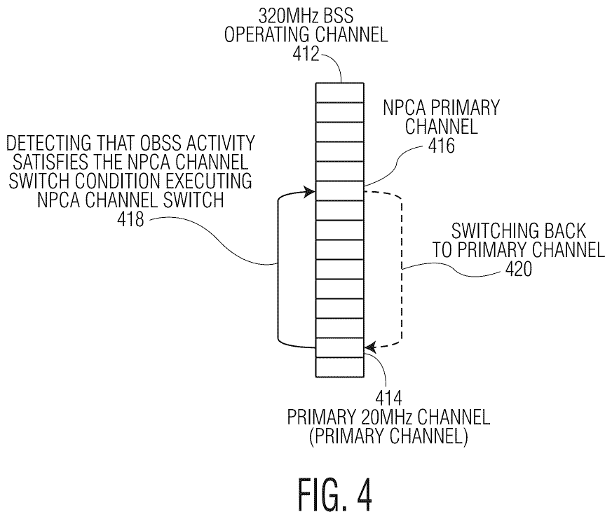

FIG. 4 depicts an example channel switch operation in accordance with an embodiment of the disclosure. For example, a 320 MHz (one million hertz) BSS operating channel 412 includes a primary 20 MHz channel (also referred to as a primary channel) 414 and at least one non-primary backoff 20 MHz channel (also referred to an NPCA primary channel) 416. In the example channel switch operation depicted in FIG. 4, a wireless device (e.g., an AP and/or a STA) can execute an NPCA primary channel switch operation 418 to switch from the primary channel 414 to the NPCA primary channel 416 to conduct frame exchanges in the NPCA primary channel 416 when the wireless device detects that an Overlapping Basic Service Set (OBSS) activity satisfies an NPCA primary channel switch condition, for example, the length of an OBSS transmit opportunity (TXOP) or an OBSS PPDU (e.g., 3 milliseconds (ms)) is longer than the OBSS activity threshold (e.g., 512 microseconds (μs)), and execute a primary channel switch operation 420 to switch from the NPCA primary channel 416 back to the primary channel 414 to conduct frame exchanges in the primary channel 414, for example, at the end of the OBSS TXOP or the OBSS PPDU. In some embodiments, after switching to the NPCA primary channel 416, a downlink (DL) multi-user Request to Send (MU-RTS), an uplink (UL) Clear to Send (CTS), a DL aggregate MAC protocol data unit (A-MPDU), and/or an UL block acknowledgement (BA) are successively transmitted. In some embodiments, after switching back to the primary channel 414, a DL RTS and an UL CTS or another control frame exchange are transmitted for the TXOP holder to check whether the TXOP responder switches back to the primary channel 414. Although the BSS operating channel 412 is depicted in FIG. 4 as having a bandwidth of 320 MHz, in other embodiments, the BSS operating channel 412 has a bandwidth higher than 320 MHz (e.g., 480 MHz) or a bandwidth lower than 320 MHz (e.g., 160 MHz). In addition, although the primary channel 414 and the NPCA primary channel 416 are depicted in FIG. 4 as having a bandwidth of 20 MHz, in other embodiments, at least one of the primary channel 414 and the NPCA primary channel 416 has a bandwidth higher than 20 MHz (e.g., 40 MHz) or a bandwidth lower than 20 MHz (e.g., 10 MHz).

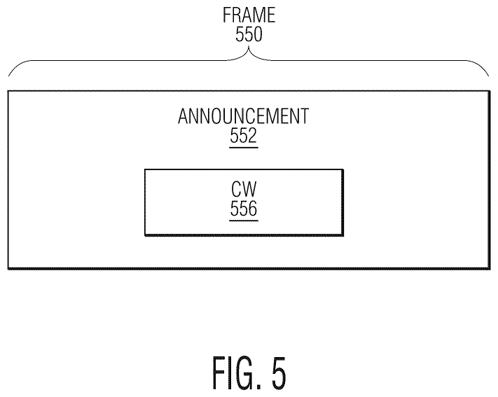

FIG. 5 illustrates a frame format 550 in accordance with an embodiment of the disclosure. The frame format 550 illustrated in FIG. 5 can be used for communications by the wireless communications system 100 depicted in FIG. 1, by a STA/AP affiliated with the multi-link (ML) communications system 200 depicted in FIG. 2, and/or the wireless device 300 depicted in FIG. 3. In the embodiment depicted in FIG. 5, the frame format 550 includes an announcement 552 that may include a minimal value of contention window (CWmin) 556 that is different from the default CWmin (DCWmin), which is used for the first backoff of a wireless station (STA) in an NPCA primary channel). In some embodiments, the announcement 552 may include other information, for example, information regarding an OBSS activity (e.g., the OBSS activity threshold where if time of the OBSS activity is longer than the OBSS activity threshold, the switch to NPCA primary channel is allowed, whether the OBSS activity includes an OBSS Physical Layer Protocol Data Unit (PPDU) or an OBSS transmit opportunity (TXOP)) in a primary channel.

Some issues related to NPCA that need to be clarified. For example, the CWmin when switching to an NPCA primary channel needs to be adaptive to the number of STAs supporting NPCA in a BSS. In addition, a STA and an AP may switch to an NPCA primary channel because of different OBSS activities. In another example, the detecting of an OBSS activity in an NPCA primary channel may have influence to the staying in the NPCA primary channel.

Some implementations of staying on an NPCA primary channel, for example, by the wireless communications system 100 depicted in FIG. 1, the AP/STA of the multi-link (ML) communications system 200 in a link depicted in FIG. 2, and/or the wireless device 300 depicted in FIG. 3 are described.

In an observation, the PPDU that triggers the switch to an NPCA Primary channel could be a HE/EHT/UHR PPDU whose TXOP field in the PHY header can have a value of UNSPECIFIED or a valid value to indicate the remaining TXOP time.

In some embodiments, in a first Solution the NPCA switch is always based on OBSS TXOP. In some embodiments, when an initial control frame carried in a PPDU is detected or a HE/EHT/UHR PPDU whose TXOP field in a PHY header with a valid value to indicate the remaining TXOP time is detected, a STA and/or an AP switch to an NPCA primary channel and stay in the NPCA primary channel per the remaining time of the TXOP if the sum of the remaining time and the PPDU remaining time is longer than the threshold announced by the AP. In some embodiments, the remaining TXOP time starts at the end time of the HE/EHT/UHR PPDU. In some embodiments, the remaining TXOP time starts at the end time of the PPDU carrying the initial control frame. In some embodiments, when the HE/EHT/UHR PPDU whose TXOP field in a PHY header with UNSPECIFIED is detected, the STA and/or the AP switch to the NPCA primary channel and stay in the NPCA primary channel until the end of the PPDU if the remaining time until the end of the PPDU is longer than the threshold announced by the AP.

In some embodiments, in a second Solution, an AP announces whether the OBSS activity triggers the switch operation to the NPCA primary channel is a PPDU type of OBSS activity or a TXOP type of OBSS activity. In some embodiments, if the AP announces the OBSS activity is an OBSS TXOP type activity, the STA and/or the AP stay in the NPCA primary channel until the end of the OBSS TXOP, otherwise the STA and/or the AP stays in the NPCA primary channel until the end of an OBSS PPDU.

Some implementations of staying on different view of OBSS TXOP on a primary channel, for example, by the wireless communications system 100 depicted in FIG. 1, the STA/AP of multi-link (ML) device in a link of the multi-link communications system 200 depicted in FIG. 2, and/or the wireless device 300 depicted in FIG. 3 are described.

In an observation, an AP and a STA may switch to an NPCA primary channel because of different OBSS activities in which case the AP and the STA have different view of the ending time of the OBSS activities in a primary channel.

In some embodiments, in a first Solution, when an initial control frame of a TXOP in an NPCA primary channel indicates a TXOP ending that is after a TXOP responder's time switching back to a primary channel, the TXOP responder indicates the early ending time of the TXOP by using a special User Info field of the responding Multi-STA block acknowledgement (BA) frame. In some embodiments, a MU-RTS is not allowed as the initial control frame in the NPCA primary channel.

In some embodiments, in a second Solution, when an initial control frame of a TXOP in an NPCA primary channel indicates a TXOP ending that is after the TXOP responder's time switching back to a primary channel, the TXOP responder indicates the early ending time of the TXOP by using a special User Info field of the responding Multi-STA BA frame if the TXOP responder supports in-device co-existence.

Some implementations of CW on an NPCA primary channel, for example, by the wireless communications system 100 depicted in FIG. 1, the STA/AP of multi-link (ML) device in a link of the multi-link communications system 200 depicted in FIG. 2, and/or the wireless device 300 depicted in FIG. 3 are described.

In an observation, the default CWmin (DCWmin) as CW for backoff on an NPCA primary channel may be too aggressive when many STAs switch to the NPCA primary channel, while the large CW may not be good when only a few STAs switch to the NPCA primary channel.

In some embodiments, DCWmin is defined for a STA's first backoff when switch to an NPCA primary channel if the AP does not announce the CWmin for the backoff on NPCA primary channel. In some embodiments, an AP can announce a CWmin that is different from the DCWmin, e.g., 2*(DCWmin+1)−1, 4*(DCwmin+1)−1 for a STA's first backoff when switch to the NPCA primary channel.

Some implementations of OBSS activity detection on an NPCA primary channel, for example, by the wireless communications system 100 depicted in FIG. 1, the STA/AP of multi-link (ML) device in a link of the multi-link communications system 200 depicted in FIG. 2, and/or the wireless device 300 depicted in FIG. 3 are described.

In an observation, a STA/AP switching to an NPCA primary channel because of the OBSS activity on a primary channel needs to stay in the NPCA primary channel until the end of the OBSS activity. However, the STA/AP may detect the NPCA primary channel busy because of an OBSS activity. In this case, the staying in the NPCA primary channel may not help with traffic congestion.

In some embodiments, a STA/AP switching to an NPCA primary channel because of an OBSS activity on a primary channel needs to stay in the NPCA primary channel until the end of the OBSS activity minus the STA/AP's delay of switching back to the primary channel with the following exception:
the STA/AP detects an OBSS activity in the NPCA primary channel that does not allow the STA/AP to conduct any frame exchange until the time when the STA/AP switches back to the primary channel.

Some implementations of switching to an NPCA primary channel, for example, by the wireless communications system 100 depicted in FIG. 1, the STA/AP of multi-link (ML) device in a link of multi-link (ML) communications system 200 depicted in FIG. 2, and/or the wireless device 300 depicted in FIG. 3 are described.

In an observation, when the detection of an OBSS High Efficiency (HE)/Extremely High Throughput (EHT)/Ultra High Reliability (UHR) Physical Layer Protocol Data Unit (PPDU) in a primary channel triggers the switch to an NPCA primary channel, an AP or a STA may have the different view from its peer device when its peer device switches to the NPCA primary channel. The initial control frame may be transmitted to the peer device when the peer device is not ready to receive the PPDU.

In some embodiments, if/when an OBSS HE/EHT/UHR PPDU is received in a primary channel, the reference time to switch to an NPCA primary channel is the end time of the received Universal Signal (U-SIG)/HE-SIG (Signal)-A.

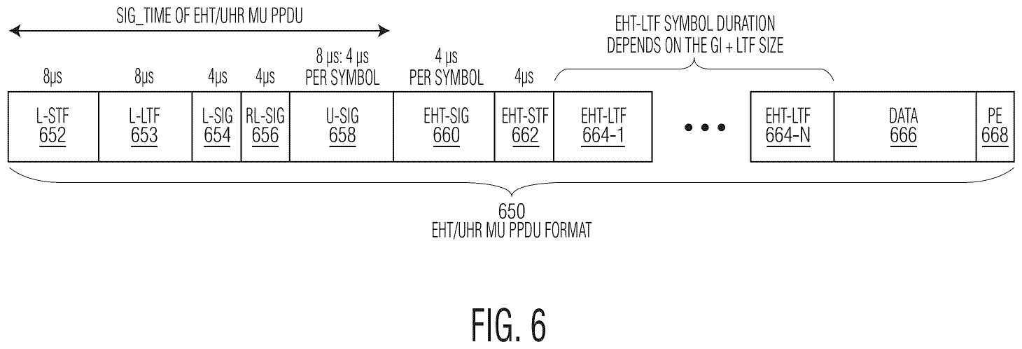

FIG. 6 illustrates an EHT/UHR MU PPDU format 650 in accordance with an embodiment of the disclosure. The EHT/UHR MU PPDU format 650 illustrated in FIG. 6 can be used for communications by the wireless communications system 100 depicted in FIG. 1, the STA/AP of multi-link (ML) device in a link of multi-link (ML) communications system 200 depicted in FIG. 2, and/or the wireless device 300 depicted in FIG. 3. In the embodiment depicted in FIG. 6, the EHT/UHR MU PPDU format 650 includes a legacy short training field (L-STF) field 652 (e.g., 8 microseconds (μs)) that may contain L-STF information, a Legacy Long Training Field (L-LTF) field 653 (e.g., 8 μs) that may contain L-LTF information, a Legacy Signal Field (L-SIG) field 654 (e.g., 4 μs) that may contain L-SIG information, a Repeated Legacy Signal (RL-SIG) field 656 (e.g., 4 μs) that may contain RL-SIG information, a Universal Signal (U-SIG) field 658 (e.g., 8 μs: 4 μs per symbol) that may contain U-SIG information, an Extremely High Throughput Signal (EHT-SIG) field 660 (e.g., 4 μs per symbol) that may contain EHT-SIG information, an Extremely High Throughput Short Training (EHT-STF) field 662 (e.g., 4 μs) that may contain EHT-STF information, one or more Extremely High Throughput Long Training (EHT-LTF) fields 664-1, . . . , 664-N (N being a positive integer) that may contain EHT-LTF information (EHT-LTF symbol duration may depend on the guard interval (GI)+LTF size), a data field 666 that may contain payload data, and a PE field 668 that may contain PE data. In the embodiment depicted in FIG. 6, the SIG_TIME of the EHT/UHR MU PPDU format 650 includes the duration of the L-STF field 652 (e.g., 8 μs), the L-LTF field 653 (e.g., 8 μs), the L-SIG field 654 (e.g., 4 μs), the RL-SIG field 656 (e.g., 4 μs), and the U-SIG field 658 (e.g., 8 μs: 4 μs per symbol).

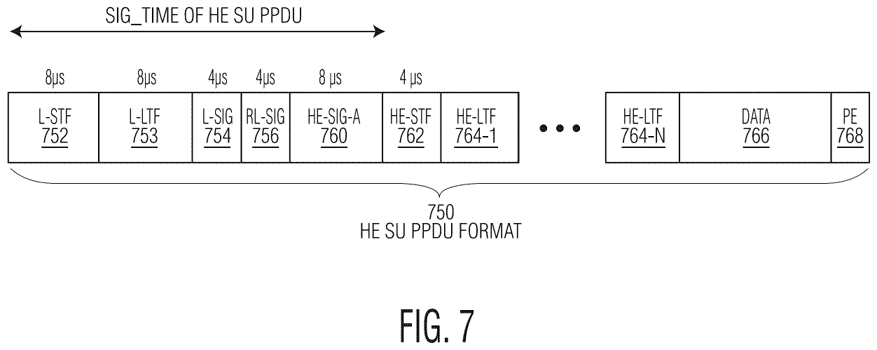

FIG. 7 illustrates a HE SU PPDU format 750 in accordance with an embodiment of the disclosure. The HE SU PPDU format 750 illustrated in FIG. 7 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 7, the HE SU PPDU format 750 includes an L-STF field 752 (e.g., 8 μs) that may contain L-STF information, an L-LTF field 753 (e.g., 8 μs) that may contain L-LTF information, an L-SIG field 754 (e.g., 4 μs) that may contain L-SIG information, an RL-SIG field 756 (e.g., 4 μs) that may contain RL-SIG information, a HE-SIG-A field 760 (e.g., 8 μs) that may contain HE-SIG information, a High-Efficiency Short Training (HE-STF) field 762 (e.g., 4 μs) that may contain HE-STF information, one or more High-Efficiency Long Training (HE-LTF) fields 764-1, . . . , 764-N (N being a positive integer) that may contain HE-LTF information (HE-LTF symbol duration may depend on the Guard Interval (GI)+LTF size), a data field 766 that may contain payload data, and a Packet Extension (PE) field 768 that may contain PE data. In the embodiment depicted in FIG. 7, the SIG_TIME of the HE SU PPDU format 750 includes the duration of the L-STF field 752 (e.g., 8 μs), the L-LTF field 753 (e.g., 8 μs), the L-SIG field 754 (e.g., 4 μs), the RL-SIG field 756 (e.g., 4 μs), and the HE-SIG-A field 760 (e.g., 8 μs).

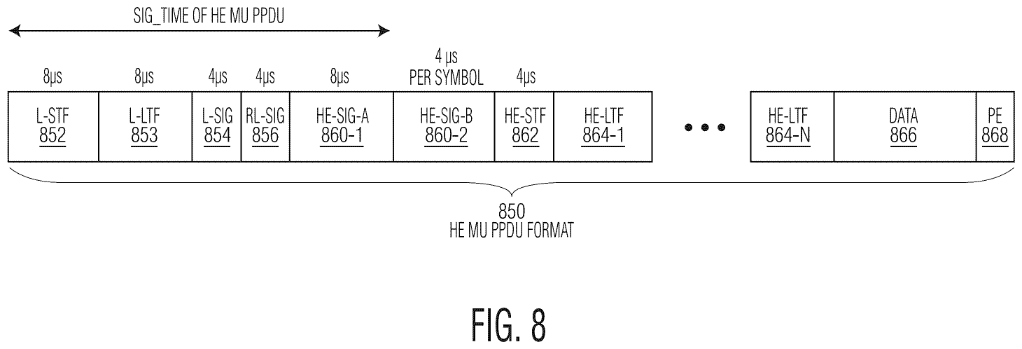

FIG. 8 illustrates a HE MU PPDU format 850 in accordance with an embodiment of the disclosure. The HE MU PPDU format 850 illustrated in FIG. 8 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 8, the HE MU PPDU format 850 includes an L-STF field 852 (e.g., 8 μs) that may contain L-STF information, an L-LTF field 853 (e.g., 8 μs) that may contain L-LTF information, an L-SIG field 854 (e.g., 4 μs) that may contain L-SIG information, an RL-SIG field 856 (e.g., 4 μs) that may contain RL-SIG information, a HE-SIG-A field 860-1 (e.g., 8 μs) that may contain HE-SIG information, a HE-SIG-B field 860-2 (e.g., 4 μs per symbol) that may contain HE-SIG information, a HE-STF field 862 (e.g., 4 μs) that may contain HE-STF information, one or more HE-LTF fields 864-1, . . . , 864-N (N being a positive integer) that may contain HE-LTF information (HE-LTF symbol duration may depend on the GI+LTF size), a data field 866 that may contain payload data, and a PE field 868 that may contain PE data. In the embodiment depicted in FIG. 8, the SIG_TIME of the HE MU PPDU format 850 includes the duration of the L-STF field 852 (e.g., 8 μs), the L-LTF field 853 (e.g., 8 μs), the L-SIG field 854 (e.g., 4 μs), the RL-SIG field 856 (e.g., 4 μs), and the HE-SIG-A field 860-1 (e.g., 8 μs).

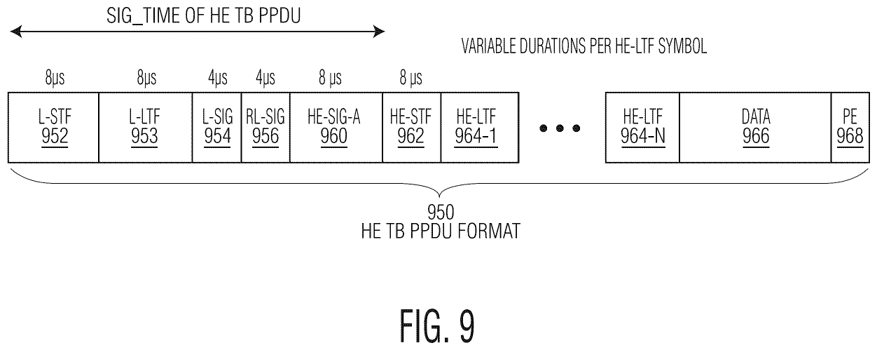

FIG. 9 illustrates a HE TB PPDU format 950 in accordance with an embodiment of the disclosure. The HE TB PPDU format 950 illustrated in FIG. 9 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 9, the HE TB PPDU format 950 includes an L-STF field 952 (e.g., 8 μs) that may contain L-STF information, an L-LTF field 953 (e.g., 8 μs) that may contain L-LTF information, an L-SIG field 954 (e.g., 4 μs) that may contain L-SIG information, an RL-SIG field 956 (e.g., 4 μs) that may contain RL-SIG information, a HE-SIG-A field 960 (e.g., 8 μs) that may contain HE-SIG information, a HE-STF field 962 (e.g., 8 μs) that may contain HE-STF information, one or more HE-LTF fields 964-1, . . . , 964-N (N being a positive integer) that may contain HE-LTF information (variable durations per HE-LTF symbol), a data field 966 that may contain payload data, and a PE field 968 that may contain PE data. In the embodiment depicted in FIG. 9, the SIG_TIME of the HE TB PPDU format 950 includes the duration of the L-STF field 952 (e.g., 8 μs), the L-LTF field 953 (e.g., 8 μs), the L-SIG field 954 (e.g., 4 μs), the RL-SIG field 956 (e.g., 4 μs), and the HE-SIG-A field 960 (e.g., 8 μs).

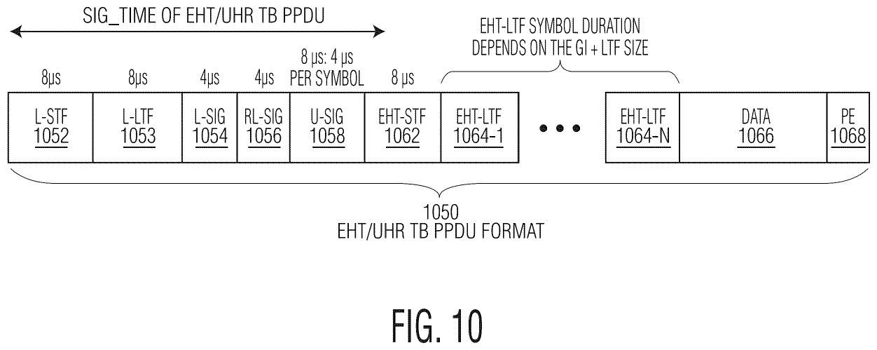

FIG. 10 illustrates an EHT/UHR TB PPDU format 1050 in accordance with an embodiment of the disclosure. The EHT/UHR TB PPDU format 1050 illustrated in FIG. 10 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 10, the EHT/UHR TB PPDU format 1050 includes an L-STF field 1052 (e.g., 8 μs) that may contain L-STF information, an L-LTF field 1053 (e.g., 8 μs) that may contain L-LTF information, an L-SIG field 1054 (e.g., 4 μs) that may contain L-SIG information, an RL-SIG field 1056 (e.g., 4 μs) that may contain RL-SIG information, a U-SIG field 1058 (e.g., 8 μs: 4 μs per symbol) that may contain U-SIG information, an EHT-STF field 1062 (e.g., 8 μs) that may contain HE-STF information, one or more EHT-LTF fields 1064-1, . . . , 1064-N (N being a positive integer) that may contain EHT-LTF information (EHT-LTF symbol duration may depend on the GI+LTF size), a data field 1066 that may contain payload data, and a PE field 1068 that may contain PE data. In the embodiment depicted in FIG. 10, the SIG_TIME of the EHT/UHR TB PPDU format 1050 includes the duration of the L-STF field 1052 (e.g., 8 μs), the L-LTF field 1053 (e.g., 8 μs), the L-SIG field 1054 (e.g., 4 μs), the RL-SIG field 1056 (e.g., 4 μs), and the U-SIG field 1058 (e.g., 8 μs: 4 μs per symbol).

Some implementations of static channel puncture in an NPCA primary channel, for example, by the wireless communications system 100 depicted in FIG. 1, the multi-link (ML) communications system 200 depicted in FIG. 2, and/or the wireless device 300 depicted in FIG. 3 are described.

When the static channel puncture on an NPCA primary channel includes a primary channel as unpunctured channel, the TXOP with a non-AP STA as the TXOP holder cannot has the bandwidth (BW) that is wider than a half of the BW of the BSS operating channel. The reason is that at least the primary channel is punctured from the unpunctured 20 MHz channel.

When the static channel puncture on an NPCA primary channel includes a primary channel as unpunctured channel, the TXOP with an AP as the TXOP holder cannot has the BW that is wider than a half of the bandwidth (BW) of the BSS operating channel if a downlink (DL) PPDU does not include a Trigger frame (Trigger information in HE Control field). The reason is that at least the primary channel is punctured from the unpunctured 20 MHz channel.

In some embodiments, if an AP announces its static channel puncture information for its NPCA primary channel, the static channel puncture information for its NPCA primary channel at least announces the primary channel as being punctured.

In some embodiments, a method of announcing the OBSS activity type for NPCA switch and supporting frame exchanges between a first device and a second device in a primary channel is busy because of OBSS activity being same as the announced OBSS activity type for NPCA switch involves announcing by the first device whether the OBSS activity type for NPCA switch is TXOP or PPDU, and switching, by the first and second devices, to the NPCA primary channel if detecting the OBSS activity being the same as the announced OBSS activity type is longer than the threshold announced by the first device, and conducting, by the first device and the second device, the frame exchanges in the NPCA primary channel until the end of the OBSS activity. In some embodiments, the first device announces the CWmin of the first backoff in the NPCA primary channel. In some embodiments, the CWmin of the first backoff in the NPCA primary channel is one of a default CWmin (DCWmin), 2*(DCWmin+1)−1.

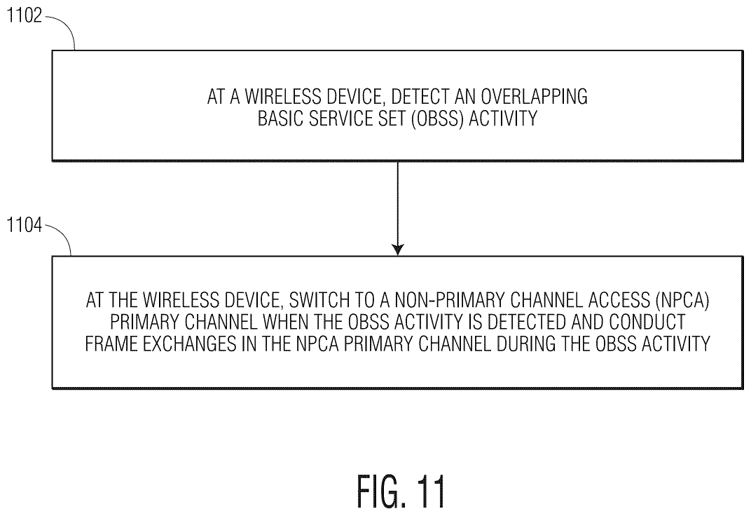

FIG. 11 is a process flow diagram of a method for wireless communications in accordance with an embodiment of the disclosure. At block 1102, at a first wireless device, an Overlapping Basic Service Set (OBSS) activity is detected, for example, in a primary channel of a BSS operating channel. At block 1104, the first wireless device switches to a Non-Primary Channel Access (NPCA) primary channel when the OBSS activity is detected and frame exchanges are conducted in the NPCA primary channel during the OBSS activity. In some embodiments, the frame exchanges are conducted with a second wireless device in the NPCA primary channel during the OBSS activity, the first wireless device includes a wireless access point (AP), and the second wireless device includes a non-AP station (STA) associated with the wireless AP. In some embodiments, the first wireless device is switched from a primary channel to the NPCA primary channel when the OBSS activity is detected. In some embodiments, the wireless STA switches from the primary channel to the NPCA primary channel when the OBSS activity is detected. In some embodiments, an announcement regarding whether the OBSS activity type is an OBSS Physical Layer Protocol Data Unit (PPDU) or an OBSS transmit opportunity (TXOP) is generated. In some embodiments, the OBSS activity includes the OBSS PPDU, and the NPCA primary channel is switched to if remaining time of the OBSS PPDU is longer than an OBSS activity threshold. In some embodiments, the frame exchanges end no later than an end of the OBSS PPDU. In some embodiments, the OBSS activity includes the OBSS TXOP, and the NPCA primary channel is switched to if remaining time of the OBSS TXOP is longer than an OBSS activity threshold. In some embodiments, the frame exchanges end no later than an end of the OBSS TXOP. In some embodiments, the first wireless device continues to communicate in the NPCA primary channel until an end of the OBSS PPDU when the OBSS activity includes the OBSS PPDU or until an end of the OBSS TXOP when the OBSS activity includes the OBSS TXOP. In some embodiments, an announcement regarding a CWmin of a first backoff of a wireless station (STA) in the NPCA primary channel is generated. In some embodiments, the CWmin is one of 2*(DCWmin+1)−1 and 4*(DCWmin+1)−1, and DCWmin represents a default minimum CW value. In some embodiments, the first wireless device switches to the NPCA primary channel at an end time of a received Universal Signal (U-SIG) or a High Efficiency (HE)-SIG-A if an OBSS HE, Extremely High Throughput (EHT), or Ultra High Reliability (UHR) Physical Layer Protocol Data Unit (PPDU) is received in a primary channel. In some embodiments, the first wireless device is compatible with an Institute of Electrical and Electronics Engineers (IEEE) 802.11 protocol. In some embodiments, the first wireless device includes an AP/STA of a wireless multi-link device (MLD), the frame exchanges are conducted with a STA/AP of a second wireless MLD in the NPCA primary channel during the OBSS activity through a wireless link between the wireless MLD and the second wireless MLD. The first wireless device and/or the second wireless device may be the same as or similar to an embodiment of the AP 106, and the STA 110-1, . . . , or 110-n depicted in FIG. 1, the APs 206-1, 206-2, and the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to detect an Overlapping Basic Service Set (OBSS) activity; and
a transceiver configured to switch to a Non-Primary Channel Access (NPCA) primary channel when the OBSS activity is detected and to conduct a plurality of frame exchanges in the NPCA primary channel during the OBSS activity.

2. The wireless device of claim 1, wherein the controller is further configured to generate an announcement regarding whether the OBSS activity comprises an OBSS Physical Layer Protocol Data Unit (PPDU) or an OBSS transmit opportunity (TXOP).

3. The wireless device of claim 2, wherein the OBSS activity comprises the OBSS PPDU, and wherein the wireless device switches to the NPCA primary channel if remaining time of the OBSS PPDU is longer than an OBSS activity threshold.

4. The wireless device of claim 3, wherein the frame exchanges end no later than an end of the OBSS PPDU.

5. The wireless device of claim 2, wherein the OBSS activity comprises the OBSS TXOP, and wherein the wireless device switches to the NPCA primary channel if remaining time of the OBSS TXOP is longer than an OBSS activity threshold.

6. The wireless device of claim 5, wherein the frame exchanges end no later than an end of the OBSS TXOP.

7. The wireless device of claim 1, wherein the controller is configured to generate an announcement regarding a contention window (CW) of a first backoff of a wireless station (STA) in the NPCA primary channel.

8. The wireless device of claim 7, wherein the CW is one of 2*(CWmin+1)−1 and 4*(CWmin+1)−1, and wherein CWmin represents a minimum CW value.

9. The wireless device of claim 1, wherein the controller is further configured to switch to the NPCA primary channel at an end time of a received Universal Signal (U-SIG) or a High Efficiency (HE)-SIG-A if an OBSS HE, Extremely High Throughput (EHT), or Ultra High Reliability (UHR) Physical Layer Protocol Data Unit (PPDU) is received in a primary channel.

10. The wireless device of claim 1, wherein the wireless device is compatible with an Institute of Electrical and Electronics Engineers (IEEE) 802.11 protocol.

11. The wireless device of claim 1, wherein the wireless device comprises a wireless multi-link device (MLD), and wherein the transceiver comprises a wireless transceiver configured to conduct the frame exchanges with a second wireless MLD in the NPCA primary channel during the OBSS activity through a plurality of wireless links between the wireless MLD and the second wireless MLD.

12. A method for wireless communications, the method comprising:
at a first wireless device, detecting an Overlapping Basic Service Set (OBSS) activity; and
at the first wireless device, switching to a Non-Primary Channel Access (NPCA) primary channel when the OBSS activity is detected and conducting a plurality of frame exchanges in the NPCA primary channel during the OBSS activity.

13. The method of claim 12, further comprising generating an announcement regarding whether the OBSS activity comprises an OBSS Physical Layer Protocol Data Unit (PPDU) or an OBSS transmit opportunity (TXOP).

14. The method of claim 13, wherein the OBSS activity comprises the OBSS PPDU, and wherein switching to the NPCA primary channel comprises switching to the NPCA primary channel if remaining time of the OBSS PPDU is longer than an OBSS activity threshold.

15. The method of claim 14, wherein the frame exchanges end no later than an end of the OBSS PPDU.

16. The method of claim 13, wherein the OBSS activity comprises the OBSS TXOP, and wherein switching to the NPCA primary channel comprises switching to the NPCA primary channel if remaining time of the OBSS TXOP is longer than an OBSS activity threshold.

17. The method of claim 16, wherein the frame exchanges end no later than an end of the OBSS TXOP.

18. The method of claim 12, further comprising generating an announcement regarding a contention window (CW) of a first backoff of a wireless station (STA) in the NPCA primary channel.

19. The method of claim 18, wherein the CW is one of 2*(CWmin+1)−1 and 4*(CWmin+1)−1, and wherein CWmin represents a minimum CW value.

20. The method of claim 12, wherein switching to the NPCA primary channel when the OBSS activity is detected comprises switching to the NPCA primary channel at an end time of a received Universal Signal (U-SIG) or a High Efficiency (HE)-SIG-A if an OBSS HE, Extremely High Throughput (EHT), or Ultra High Reliability (UHR) Physical Layer Protocol Data Unit (PPDU) is received in a primary channel.
